(19) United States
(12) Patent Application Publication
(10) Pub. No.: US 2002/0067503 A1
(43) Pub. Date: Jun. 6, 2002

(54) Printer with embedded computer

(76) Inventor: Brian C. Hiatt, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/730,075

(22) Filed: Dec. 4, 2000

(51) Int. Cl. G06F 15/16

(52) U.S. Cl. 358/1.15

(57) ABSTRACT

A computer network system having one or more computers dedicated solely to downloading already created documents and having no printer drivers or document processing application and including an integrated network printer that comprises a print engine, a formatter that includes a data processor having an output connected to the print engine, a computer data processor having an output connected to the formatter, and memory media in communication with the computer data processor.

### FIELD OF THE INVENTION

The present invention relates generally to computer network systems and more specifically to such a system having a printer with its own integrally embedded computer data processor, an operating system, storage media and applications software.

### BACKGROUND OF THE INVENTION

Traditionally, a network of computers comprises a plurality of computers with one or more network printers that service each of the computers within the network. In order for the various networked computers to utilize the services of the printers it is necessary that each of the computers contain within their respective memory media a program that controls the expression of coded characters in a particular printer, frequently referred to as a printer driver. In addition to the burdensome requirement that each network computer contain a driver for each printer that is accessed by the computer, several other disadvantages accrue to such a system.

One such drawback manifests in the large amount of data traffic that crowds the network system when all of the formatted documents created by such programs as Microsoft Word, Adobe PDF and others are transmitted on the network to a printer.

Another liability of such a system is that any network computer that merely functions to transfer documents to a printer from sources such as e-mail or a downloaded internet web page must carry an associated application in order to process each different kind of downloaded document and send it to the printer. Not only does this require the presence in each network computer's memory of all programs and applications necessary to transmit a wide selection of documents, it requires a user license for each different application on each computer.

### SUMMARY OF THE INVENTION

The present invention overcomes the hindrances and inconvenience of the traditional network system by providing a stand alone printer that eliminates the need in a network of computers for printer drivers or for application software in any computer that does not originate documents. In addition to the traditional network computers that comprise central processing units, memory storage devices, a keyboard, a monitor and a mouse, the present invention contemplates a network system having one or more driver-less client computers. The later type of computers are “bare bones,” without application software or printer drivers, arranged and equipped to transmit from e-mail or web site sources to the printer of the present invention native file formats for all types of programs and applications.

The printer of the present invention contains, in addition to the normal print engine and communications sub-systems, an integral multi-purpose computer including an operating system, memory devices, program applications and a driver for the printer portion of the combination.

### DESCRIPTION OF THE DRAWINGS

FIG. 1 is a schematic diagram of the network system and integral printer of the present invention.

### DETAILED DESCRIPTION OF THE INVENTION

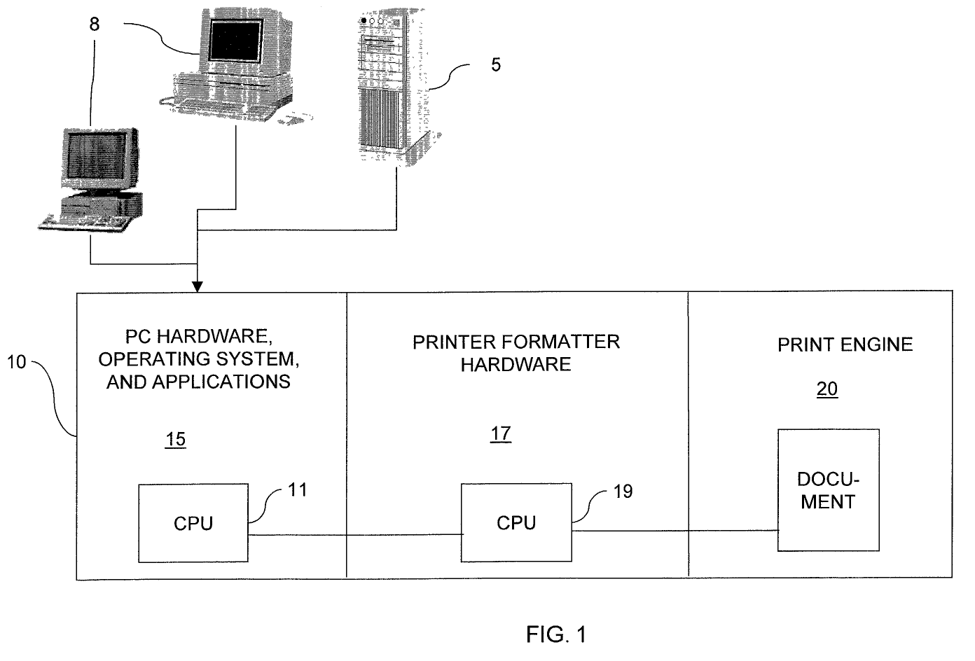

In a system of networked computers, schematically illustrated in FIG. 1, there may be one or more client computers 5 whose function is to download documents from other computers, e-mail or internet web sites. These client computers 5 would be in addition to other system computers 8 whose function is to generate original documents or graphics. While the originating computers 8 require the presence of document processing programs and printer drivers, such accessories are not necessary in those computers 5 within the network need only contain the minimum components of hardware and software to accomplish its purpose, such as an operating system and communications software.

To accommodate one or more driver-less client computers 5, the printer 10 of the present invention includes, in addition to the traditional print engine and communication sub-systems, an integral embedded computer 15 of its own. The embedded computer includes the normal hardware and software components of a typical computer, including a central processor unit 11, an operating system, permanent and RAM memory (not shown) and applications software that is associated with and processes the kinds of documents that are expected to be transmitted from the driver-less client computer 5.

In addition to the printer computer hardware and software to which reference has already been made, the printer 10 contains formatting hardware 17, including a central processor 19 that translates the printer control language coming from the printer computer CPU 11 to the formatting required of the document to be printed. From the formatting hardware the formatted data is communicated to the print engine 20 where it is transformed into recognizable hard copy.

Such a system obviates the need for printer drivers and document processing applications software in the client computers 5 that are assigned the functions of downloading documents or graphics that are already created. The system also eliminates the need for software licenses for applications, except for those residing in the printer computer.

What is claimed is:

1. Computer related apparatus that expresses coded characters as hard copy, comprising,
(a) a print engine
(b) a formatter including a data processor having an output connected to the print engine,
(c) a computer data processor having an output connected to the formatter, and
(d) memory media in communication with the computer data processor

2. The combination of claim 1 where the memory media includes a computer operating system.

3. The combination of claim 2 where the memory media includes application software.

4. The combination of claim 3 where the memory media includes a printer driver.

5. A computer network system comprising,
(a) at least two network computers,
(b) at least one network printer,
(c) a communications network interconnecting the computers and the at least one network printer, and where
(d).at least one of the network computers is without a printer driver and a document processing application.

6. The combination of claim 5 where the at least one network printer comprises:
(a) a print engine
(b) a formatter including a data processor having an output connected to the print engine,
(c) a computer data processor having an output connected to the formatter, and
(d) memory media in communication with the computer data processor.

7. The combination of claim 6 where the network printer further comprises at least one document processing application residing in the memory media.
